(19) United States
(12) Patent Application Publication
(10) Pub. No.: US 2011/0090321 A1
(43) Pub. Date: Apr. 21, 2011

(54) Display device, display method and computer program

(75) Inventors: Makoto Nakagawa, Tokyo (JP); Yuji Nakahata, Kanagawa (JP); Toshiaki Suzuki, Kanagawa (JP)

(73) Assignee: Sony Corporation, Tokyo (JP)

(21) Appl. No.: 12/925,168

(22) Filed: Oct. 13, 2010

(30) Foreign Application Priority Data
Oct. 21, 2009 (JP) P2009-242079

(51) Int. Cl. H04N 13/04

(52) U.S. Cl. 348/51; 348/E13.075

(57) ABSTRACT

A display system and display method in which a gradation difference between a first frame and a second frame of a video signal is detected, a determination is made as to whether the gradation difference is of a first state or a second state, and a target value of an output of a display is changed based on the result of the determination.

### CROSS-REFERENCE TO RELATED APPLICATION

The present application claims priority from Japanese Patent Application No. JP 2009-242079 filed in the Japanese Patent Office on Oct. 21, 2009, the entire content of which is hereby incorporated herein by reference.

### BACKGROUND OF THE INVENTION

1. Field of the Invention

The present invention relates to a display device, a display method and a computer program.

2. Description of the Related Art

Display devices exist in which an image displayed on a screen is perceived by a viewer as a stereoscopic image. A time division display scheme is known as a technique to cause the viewer to perceive an image displayed on this type of display device as a stereoscopic image. In the time division display scheme, an image for the left eye and an image for the right eye are alternately displayed on the entire screen at very short intervals (See Japanese Patent Application Publication No. JP-A-1997-138384, Japanese Patent Application Publication No. JP-A-2000-36969 and Japanese Patent Application Publication No. JP-A-2003-45343).

An image displayed using the time division display scheme can be perceived by the viewer as a stereoscopic image through shutter glasses worn by the viewer. During a period in which an image for the left eye is displayed, a left eye shutter (a liquid crystal shutter, for example) of the shutter glasses is opened to allow the light from the screen to pass through, and a right eye shutter of the shutter glasses is closed to shut off the light from the screen. On the other hand, during a period in which an image for the right eye is displayed, the left eye shutter of the shutter glasses is closed to shut off the light from the screen, and the right eye shutter of the shutter glasses is opened to allow the light from the screen to pass through.

However, with this type of display device, crosstalk may occur due to characteristics of the display device and the shutter glasses, such as an insufficient liquid crystal response speed (when a liquid crystal panel is used as a screen) and insufficient contrast of the liquid crystal shutters of the shutter glasses. Crosstalk is a phenomenon in which a part of the image for the right eye leaks in the left eye and a part of the image for the left eye leaks in the right eye.

As a method to improve crosstalk, a method has been proposed in which the display panel is driven at a high speed (for example, with 240 Hz), and an image for the left eye and an image for the right eye are each displayed on the screen two times repeatedly, and the shutter glasses are opened only in a period during which each of the images is displayed for the second time. Also, a method has been proposed in which a back light is turned on only in a period during which each of the images is displayed for the second time. Further, as method to offset an insufficient liquid crystal response speed, overdrive processing has been proposed in which an applied voltage value for each pixel of a liquid crystal panel is corrected.

### SUMMARY OF THE INVENTION

However, in known overdrive processing for two-dimensional (2D) images, methods and setting values are based on the premise of a response from a steady state. Thus, in the display of three-dimensional (3D) images, when the image for the right eye and the image for the left eye are constantly repeatedly displayed and liquid crystal in an interior of a panel does not settle into a steady state, it is necessary to apply methods and setting values of overdrive processing that are different to those applied in overdrive processing for 2D images.

A correction amount of a voltage value applied by overdrive processing is larger in a case of overdrive processing for 2D images based on the premise of a response from a steady state than in a case of overdrive processing for 3D images in which the liquid crystal does not settle into a steady state. As a result, if overdrive processing for 2D images is performed while displaying 3D images, deviation from a target luminance occurs, and, as shown in FIG. 11, there is a resulting deviation from the target luminance. In other words, crosstalk occurs.

In addition, even in the case of displaying 3D images, if overdrive processing for 3D images is performed in a case where the liquid crystal has reached a steady state, such as a situation in which there is no parallax, it requires time to reach a luminance that is a target, and a phenomenon known as “tailing” occurs, as shown in FIG. 12. Furthermore, even in the case of displaying 3D images, when shifting from a state in which the liquid crystal has reached a steady state, such as a situation in which there is no parallax, to display of 3D images by repeatedly displaying the image for the left eye and the image for the right eye, regardless of whether overdrive processing for 2D images is performed or overdrive processing for 3D images is performed, the phenomena of crosstalk and tailing occur, as shown in FIG. 13.

In light of the foregoing, it is desirable to provide a novel and improved display device, display method and computer program that are capable of suppressing the occurrence of crosstalk and tailing phenomena by appropriately performing overdrive processing using different parameters.

In view of the above, the present system and method is provided. In the present system and method, a gradation difference between a first frame and a second frame of a video signal is detected, and a determination is made as to whether the gradation difference is of a first state or a second state. Based on the result of the determination, a target value of an output of a display is changed.

### BRIEF DESCRIPTION OF THE DRAWINGS

FIG. 1 is an explanatory diagram showing an outer appearance of a display device 100 according to an embodiment of the present invention;

FIG. 2 is an explanatory diagram showing a functional configuration of the display device 100 according to the embodiment of the present invention;

FIG. 3A is an explanatory diagram showing an example of an overdrive look up table;

FIG. 3B is an explanatory diagram showing an example of an overdrive look up table;

FIG. 3C is an explanatory diagram showing an example of an overdrive look up table;

FIG. 3D is an explanatory diagram showing an example of an overdrive look up table;

FIG. 4 is an explanatory diagram showing a flow of a series of overdrive processing;

FIG. 5 is an explanatory diagram showing a flow of a series of overdrive processing;

FIG. 6A is an explanatory diagram showing an example of an overdrive look up table;

FIG. 6B is an explanatory diagram showing an example of a replacement look up table;

FIG. 6C is an explanatory diagram showing an example of an overdrive look up table;

FIG. 6D is an explanatory diagram showing an example of a replacement look up table;

FIG. 7 is an explanatory diagram showing a flow of a series of overdrive processing;

FIG. 8 is an explanatory diagram showing a flow of a series of overdrive processing;

FIG. 9 is an explanatory diagram showing a flow of a series of overdrive processing;

FIG. 10 is an explanatory diagram showing results of the overdrive processing according to the embodiment of the present invention;

FIG. 11 is an explanatory diagram showing results of known overdrive processing;

FIG. 12 is an explanatory diagram showing results of known overdrive processing;

FIG. 13 is an explanatory diagram showing results of known overdrive processing; and

FIG. 14 is an explanatory diagram showing a flow of a series of overdrive processing.

### DETAILED DESCRIPTION

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Explanation will be made in the following order.

1. An embodiment of the present invention
1-1. Configuration of display device according to an embodiment of the present invention
1-2. Functional configuration of display device according to the embodiment of the present invention
1-3. Operation of display device according to the embodiment of the present invention

2. Conclusion

### 1. AN EMBODIMENT OF THE PRESENT INVENTION

### 1-1. Configuration of Display Device According to an Embodiment of the Present Invention

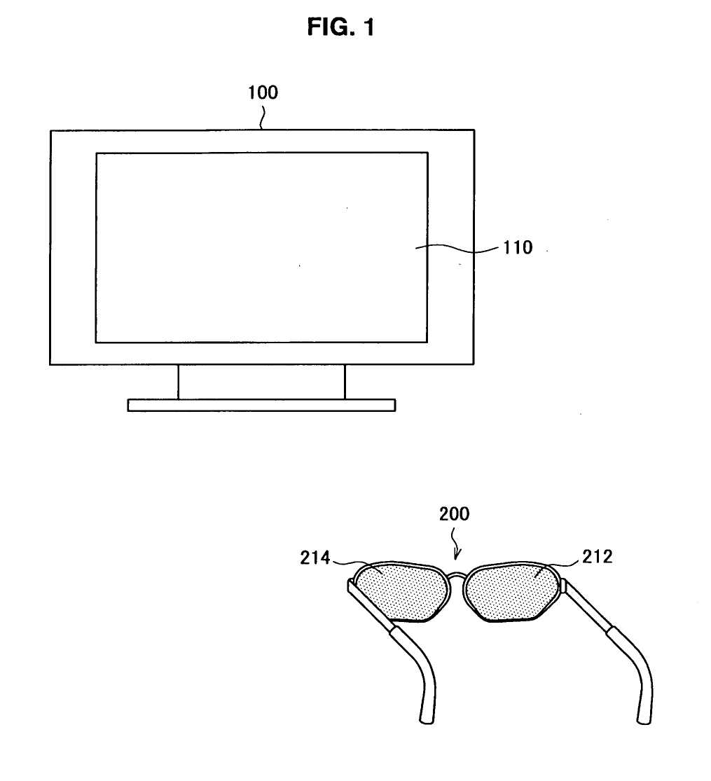

Hereinafter, a configuration of a display device 100 according to an embodiment of the present invention will be explained. First, an outer appearance of the display device 100 according to the embodiment of the present invention will be described. FIG. 1 is an explanatory diagram showing the outer appearance of the display device 100 according to the embodiment of the present invention. Additionally, FIG. 1 also shows shutter glasses 200, which are used to cause a viewer to perceive an image displayed by the display device 100 as a stereoscopic image.

The display device 100 shown in FIG. 1 is provided with an image display portion 110 that displays images. The display device 100 does not only display normal images on the image display portion 110, but can also display three-dimensional images on the image display portion 110 that are perceived by the viewer as stereoscopic images.

The configuration of the image display portion 110 will be described in more detail later. As a simple description here, the image display portion 110 includes a light source, a liquid crystal panel and a pair of polarizing plates that sandwich the liquid crystal panel. Light from the light source is polarized in a predetermined direction by passing through the liquid crystal panel and the polarizing plates.

The shutter glasses 200 include a right eye image transmission portion 212 and a left eye image transmission portion 214, which are liquid crystal shutters, for example. The shutter glasses 200 perform opening and closing operations of the right eye image transmission portion 212 and the left eye image transmission portion 214, in response to a signal transmitted from the display device 100. The viewer can perceive an image displayed on the image display portion 110 as a stereoscopic image, by looking at the light emitted from the image display portion 110 through the right eye image transmission portion 212 and the left eye image transmission portion 214 of the shutter glasses 200.

On the other hand, when a normal image is displayed on the image display portion 110, by looking at the light output from the image display portion 110 as it is, the viewer can perceive the image as the normal image.

Besides, in FIG. 1, the display device 100 is portrayed as a television receiver, but in the present invention the form of the display device 100 is naturally not limited to this example. The display device 100 according to an embodiment of the present invention may be, for example, a monitor that is used when connected to an electronic appliance such as a personal computer or the like, or it may be a mobile game console, a mobile telephone, or a portable music playback device and so on.

The outer appearance of the display device 100 according to the embodiment of the present invention has been described above. Next, a functional configuration of the display device 100 according to the embodiment of the present invention will be explained.

### 1-2. Functional Configuration of Display Device According to the Embodiment of the Present Invention

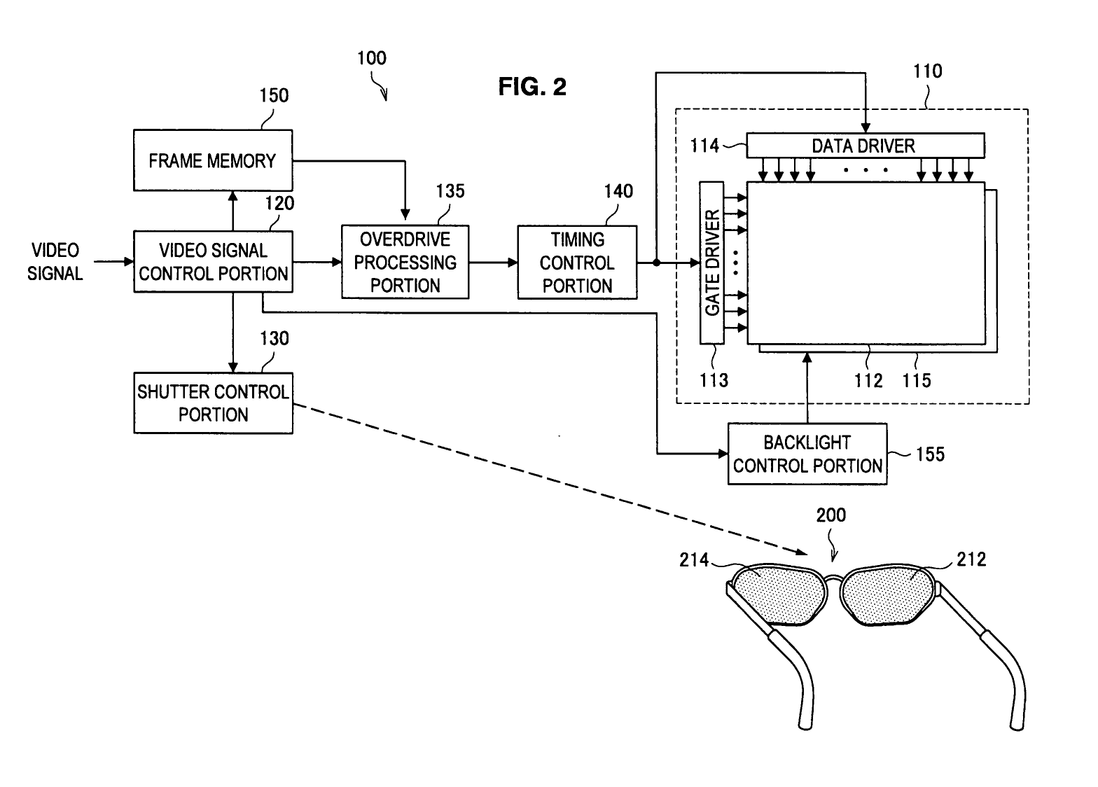

FIG. 2 is an explanatory diagram showing the functional configuration of the display device 100 according to the embodiment of the present invention. Hereinafter, the functional configuration of the display device 100 according to the embodiment of the present invention will be explained with reference to FIG. 2.

As shown in FIG. 2, the display device 100 according to the embodiment of the present invention includes an image display portion 110, a video signal control portion 120, a shutter control portion 130, an overdrive processing portion 135, a timing control portion 140, a frame memory 150, and a backlight control portion 155.

The image display portion 110 displays images in the manner described above, and when a signal is applied from an external source, display of images is performed in accordance with the applied signal. The image display portion 110 includes a display panel 112, a gate driver 113, a data driver 114 and a backlight 115.

The display panel 112 displays images in accordance with the signal applied from an external source. The display panel 112 displays images by sequentially scanning a plurality of scanning lines. Liquid crystal molecules having a predetermined orientation state are filled in a space between transparent plates, made of glass or the like, of the display panel 112. A drive scheme of the display panel 112 may be a Twisted Nematic (TN) scheme, a Vertical Alignment (VA) scheme, or an In-Place-Switching (IPS) scheme. In the following explanation, the drive scheme of the display panel 112 is the VA scheme, unless otherwise specified, but it goes without saying that the present invention is not limited to this example. Note that the display panel 112 according to the present embodiment is a display panel that can rewrite the screen at a high-speed frame rate (120 Hz or 240 Hz, for example). In the present embodiment, an image for the right eye and an image for the left eye are displayed alternately on the display panel 112 at a predetermined timing, causing the viewer to perceive a stereoscopic image.

The gate driver 113 is a driver that drives a gate bus line (not shown) of the display panel 112. A signal is transmitted from the timing control portion 140 to the gate driver 113, and the gate driver 113 outputs a signal to the gate bus line in accordance with the signal transmitted from the timing control portion 140.

The data driver 114 is a driver that generates a signal that is applied to a data line (not shown) of the display panel 112. A signal is transmitted from the timing control portion 140 to the data driver 114. The data driver 114 generates a signal to be applied to the data line, in accordance with the signal transmitted from the timing control portion 140, and outputs the generated signal.

The backlight 115 is provided on the backmost side of the image display portion 110 as seen from the side of the viewer. When an image is displayed on the image display portion 110, white light that is not polarized (unpolarized light) is output from the backlight 115 to the display panel 112 positioned on the side of the viewer. The backlight 115 may use a light-emitting diode, for example, or may use a cold cathode tube. Note that the backlight 115 shown in FIG. 2 is a surface light source, but the present invention is not limited to this form of light source. For example, the light source may be arranged around the peripheral edges of the display panel 112, and may output light to the display panel 112 by diffusing the light from the light source using a diffuser panel etc. Alternatively, for example, a point light source and a condenser lens may be used in combination in place of the surface light source.

When the video signal control portion 120 receives a video signal from an external source, the video signal control portion 120 performs various types of signal processing on the received video signal such that it is suitable for three-dimensional image display on the image display portion 110 and outputs the processed signal. The video signal on which signal processing has been performed by the video signal control portion 120 is transmitted via the overdrive processing portion 135 to the timing control portion 140. Further, when signal processing is performed in the video signal control portion 120, a predetermined signal is transmitted to the shutter control portion 130 in accordance with the signal processing. The signal processing by the video signal control portion 120 is, for example, as described below.

When a video signal to display the image for the right eye on the image display portion 110 (a right eye video signal) and a video signal to display the image for the left eye on the image display portion 110 (a left eye video signal) are received by the video signal control portion 120, the video signal control portion 120 generates, from the two received video signals, a video signal for a three-dimensional image. In the present embodiment, the video signal control portion 120 generates, from the received right eye video signal and left eye video signal, video signals to display images on the display panel 112 using time-division scheme in the following order: image for the right eye>>image for the left eye>>image for the right eye>>image for the left eye>>and so on. Here, the image for the left eye and the image for the right eye may be displayed respectively repeatedly for a plurality of frames, in such a case, the video signal control portion 120 generates video signals to display, for example, in the following order: image for the right eye>>image for the right eye>>image for the left eye>>image for the left eye>>image for the right eye>>image for the right eye>>and so on.

Further, the video signal control portion 120 performs replacement processing on video signals of some of the frames by using a predetermined lookup table (LUT). The video signals on which the replacement processing has been performed are transmitted to a frame memory 150, which will described later, and stored temporally in the frame memory 150.

The shutter control portion 130 receives a predetermined signal that is generated based on the signal processing by the video signal control portion 120, and generates a shutter control signal that controls shutter operation of the shutter glasses 200 in accordance with the predetermined signal. The shutter glasses 200 perform opening and closing operations of the right eye image transmission portion 212 and the left eye image transmission portion 214, based on the shutter control signal that is generated by the shutter control portion 130 and output from the infrared radiation emitter 150 (not shown). The backlight control portion 155 receives a predetermined signal that is generated based on the signal processing by the video signal control portion 120, and generates a backlight control signal that controls turn-on operation of the backlight in accordance with the predetermined signal.

The overdrive processing portion 135 performs a predetermined overdrive processing on the video signals generated by the video signal control portion 120 or the video signals stored in the frame memory 150. The overdrive processing portion 135 performs overdrive processing by using the lookup table stored in the overdrive processing portion 135. The display device according to the present embodiment performs overdrive processing on each of the consecutive frames that display the same image for the left eye or right eye, by using different lookup tables. Further, the overdrive processing portion 135 performs overdrive processing using different lookup tables for overdrive processing premised on a response from a transient state and for overdrive processing premised on a response from a steady state, respectively. The video signals on which overdrive processing has been performed by the overdrive processing portion 135 are transmitted to the timing control portion 140 at the subsequent stage.

In accordance with the signals transmitted from the video signal control portion 120, the timing control portion 140 generates a pulse signal that is used to operate the gate driver 113 and the data driver 114. When the pulse signal is generated by the timing control portion 140, and the gate driver 113 and the data driver 114 receive the pulse signal generated by the timing control portion 140, an image related to the signal transmitted from the video signal control portion 120 is displayed on the display panel 112.

The frame memory 150 temporally stores video signals generated based on signal processing in the video signal control portion 120. Timing at which video signals are stored in the frame memory 150 and Timing at which the video signals stored in the frame memory 150 are updated will be described later.

The functional configuration of the display device 100 according to the embodiment of the present invention has been explained above with reference to FIG. 2. Next, operation of the display device 100 according to the embodiment of the present invention will be explained.

### 1-3. Operation of Display Device According to Embodiment of Present Invention

In the display device 100 according to the embodiment of the present invention, an explanation is described of a case in which the display panel 112 is driven at a drive frequency of 240 Hz, and the image for the left eye and the image for the right eye are consecutively displayed by two frames.

In the display device 100 according to the embodiment of the present invention, at the time of overdrive processing by the overdrive processing portion 135, a 1-bit flag is set that is used in selecting an overdrive parameter (a look up table). Further, when a gray level difference between the consecutively input two images for the left eye and two images for the right eye is zero, while the next image for the left eye (or the image for the right eye) is being input, the flag is on. Note that, it is needless to mention that flag conditions are not limited to this example. Alternatively, a condition may be established in which a gray level difference between consecutively input three images for the left eye and three images for the right eye is equal to or lower than a threshold value. It is preferable to set the conditions as appropriate, taking into account the drive frequency of the display panel 112 and the response speed of the liquid crystal with which the display panel 112 is filled. In addition, the number of bits of the flag used in selecting the overdrive parameter may be increased or may be broken down into more detailed conditions.

As described above, the display device 100 according to the embodiment of the present invention performs overdrive processing using different look up tables for each of frames that are consecutive frames displaying the same image for the right eye and for the left eye. Furthermore, the overdrive processing portion 135 performs overdrive processing using different look up tables for each of overdrive processing based on a premise of a response from a transient state, and overdrive processing based on a premise of a response from a steady state. In the following explanation, a frame that first displays the image for the left eye or the image for the right eye will be referred to as a first frame, and a frame that next displays the image for the left eye or the image for the right eye will be referred to as a second frame.

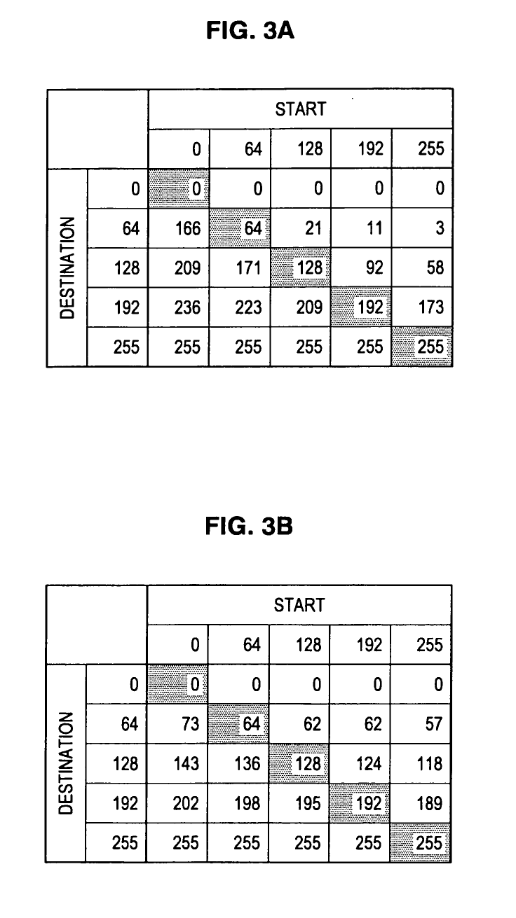

FIG. 3A to FIG. 3D are explanatory diagrams showing individual examples of an overdrive look up table (LUT) used in overdrive processing by the overdrive processing portion 135. FIG. 3A shows an example of an overdrive LUT based on the premise of a response from a transient state (hereinafter, the overdrive LUT based on the premise of a response from a transient state will be referred to as “LUT-A”). FIG. 3B is an explanatory diagram showing an example of the LUT-A for the second frame. FIG. 3C is a diagram showing an example of an overdrive LUT based on the premise of a response from a steady state (hereinafter, the overdrive LUT based on the premise of a response from a steady state will be referred to as “LUT-B”). FIG. 3D is an explanatory diagram showing an example of the LUT-B for the second frame.

Note that numbers shown in FIG. 3A to FIG. 3D indicate a gray level. The gray level is shown using 256 levels, with the darkest gradation being zero and the brightest gradation being 255. “START” indicates the gradation before overdrive processing, and “DESTINATION” indicates a target gradation of the image for the left eye and the image for the right eye after the overdrive processing by the overdrive processing portion 135. Also, the numbers in each of the tables indicate parameters applied in the overdrive processing by the overdrive processing portion 135. In this way, the feature of each of the look up tables used by the overdrive processing portion 135 is that, among combinations of a start gradation and the target gradation, for at least half or more of the combinations, a value of a correction amount (which indicates a difference between an output gradation when overdrive is applied and an output gradation when overdrive is not applied) using the LUT-A is smaller than a value of a correction amount using the LUT-B. The difference indicated by the correction amount applies in the following explanation also.

An example will be explained of overdrive processing using the overdrive LUT that has this type of parameter, in a case where the image for the right eye and the image for the left eye are consecutively displayed by two frames, the gradation of the image for the right eye being 64 and the gradation of the image for the left eye being 128.

When the first frame of the image for the left eye with a gradation of 128 is input into the overdrive processing portion 135, the second frame of the image for the right eye with a gradation of 64 is stored in the frame memory 150.

When the flag is off (namely, when the gradation of the image for the left eye that precedes the image for the right eye stored in the frame memory 150 is not 64, and there is a gradation difference with the image for the right eye stored in the frame memory 150), the overdrive processing portion 135 performs overdrive processing on the first frame of the image for the left eye (which has a gradation of 128) using the LUT-A for the first frame. The overdrive processing portion 135 performs overdrive processing on the second frame of the image for the left eye (which also has a gradation of 128) using the LUT-A for the second frame.

In this case, the START value is 64, and the DESTINATION value is 128. Thus, with respect to the first frame, 171 is output from the overdrive processing portion 135 as a gradation value, and with respect to the second frame, 136 is output from the overdrive processing portion 135 as a gradation value.

On the other hand, when the flag is on (namely, when the gradation of the image for the left eye that precedes the image for the right eye stored in the frame memory 150 is 64, and there is no gradation difference with the image for the right eye stored in the frame memory 150), the overdrive processing portion 135 performs overdrive processing on the first frame of the image for the left eye (which has a gradation of 128) using the LUT-B for the first frame. The overdrive processing portion 135 performs overdrive processing on the second frame of the image for the left eye (which has the same gradation of 128) using the LUT-B for the second frame.

In this case, the START value is 64, and the DESTINATION value is 128. Thus, with respect to the first frame, 179 is output from the overdrive processing portion 135 as a gradation value, and with respect to the second frame, 145 is output from the overdrive processing portion 135 as a gradation value.

As described above, the correction amount (which indicates a difference between an output gradation when overdrive is applied and an output gradation when overdrive is not applied) using the LUT-A is 43 for the first frame, and 8 for the second frame. The correction amount using the LUT-B is 51 for the first frame and 17 for the second frame. (The difference indicated by the correction amount applies in the following explanation also.) In this way, in the present embodiment, it is possible to set the overdrive LUT parameters such that the correction amount using the LUT-B is larger than the correction amount using the LUT-A.

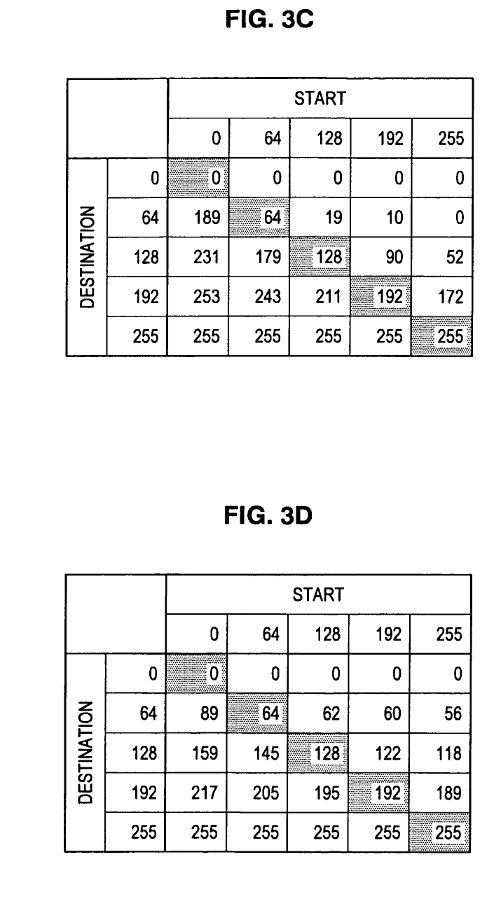

FIG. 4 is an explanatory diagram showing a flow of a series of overdrive processing by the overdrive processing portion 135 on the display device 100 according to the embodiment of the present invention.

In FIG. 4, “INPUT” indicates, in units of frames, a video signal input to the video signal control portion 120. R0, R1 etc. indicate a right eye image signal, while L0, L1, L2 etc. indicate a left eye image signal. In FIG. 4, seven frames are depicted, namely the first frame (Frame 1) to the seventh frame (Frame 7).

In addition, in FIG. 4, “FRAME MEMORY” indicates a video signal stored in the frame memory 150. FIG. 4 shows a case in which the image signal of the second frame is stored in the frame memory 150. Thus, as shown in FIG. 4, the image signal stored in the frame memory 150 is updated at a ratio of once every other frame.

Further, in FIG. 4, “OUTPUT” indicates results of overdrive processing performed on the right eye image signal or on the left eye image signal and is a video signal output from the overdrive processing portion 135, shown in units of frames. For example, with respect to the input R0, R0_{OD1} indicates an output of a result of the overdrive processing using the LUT-A for the first frame (OD LUT 1-A). Further, with respect to the input R0, R0_{OD2} indicates an output of a result of the overdrive processing using the LUT-A for the second frame (OD LUT 2-A). In addition, in FIG. 4, “FLAG” indicates a state of a flag used to select the overdrive LUT to be used by the overdrive processing portion 135.

The series of overdrive processing by the overdrive processing portion 135 will be explained with reference to FIG. 4. In the example shown in FIG. 4, it is assumed that the right eye image signal R0 and the left eye image signal L1 have the same gradation. It is assumed that the image for the left eye and the image for the right eye immediately preceding the right eye image signal R0 do not have the same gradation, and the flag in relation to the right eye image signal R0 and the left eye image signal L1 is off. As a result, until the second frame of the left eye image signal L1, the overdrive processing portion 135 applies the LUT-A to each of the image signals to perform the overdrive processing.

As R0 and L1 have the same gradation, during a period in which the subsequent R1 is input (Frame 5 and Frame 6), the flag used to select the overdrive LUT is set to be on. By setting the flag used to select the overdrive LUT to be on, the LUT-B for the first frame (OD LUT 1-B) is selected in the overdrive processing portion 135, and the overdrive processing is performed by the overdrive processing portion 135. Then, with respect to the subsequent second frame of the right eye image signal R1, the LUT-B for the second frame (OD LUT 2-B) is selected and the overdrive processing is performed by the overdrive processing portion 135.

As L1 and R1 do not have the same gradation, during a period in which the subsequent L2 is input (Frame 7 and Frame 8, Frame 8 is not shown), the flag used to select the overdrive LUT is set to be off. By setting the flag used to select the overdrive LUT to be off, the LUT-A for the first frame is selected in the overdrive processing portion 135. Note that, although not shown in FIG. 4, the LUT-A for the second frame is also selected in the overdrive processing portion 135 with respect to the subsequent second frame of the left eye image signal L2.

In this way, by comparing the difference in the gradation of the right eye image signal and the left eye image signal and switching the overdrive LUT selected for the subsequent right eye image signal or left eye image signal depending on the difference in the gradation, it becomes possible to perform overdrive processing in which the occurrence of the phenomena of crosstalk and tailing is suppressed.

Besides, in order to further improve moving image performance, the gradation of the image for the right eye or the image for the left eye to be stored in the frame memory 150 may be replaced after referring to a replacement LUT, based on the gradation of the image for the left eye or the image for the right eye and on the gradation of the image that has already been stored in the frame memory 150 at a time when the gradation of the image for the left eye or the image for the right eye is to be stored in the frame memory 150. The replacement LUT may be provided in the video signal control portion 120, for example. When the image for the left eye or the image for the right eye is stored to the frame memory 150 from the video signal control portion 120, the video signal control portion 120 may refer to the replacement LUT and replace the gradation of the image for the left eye or the image for the right eye.

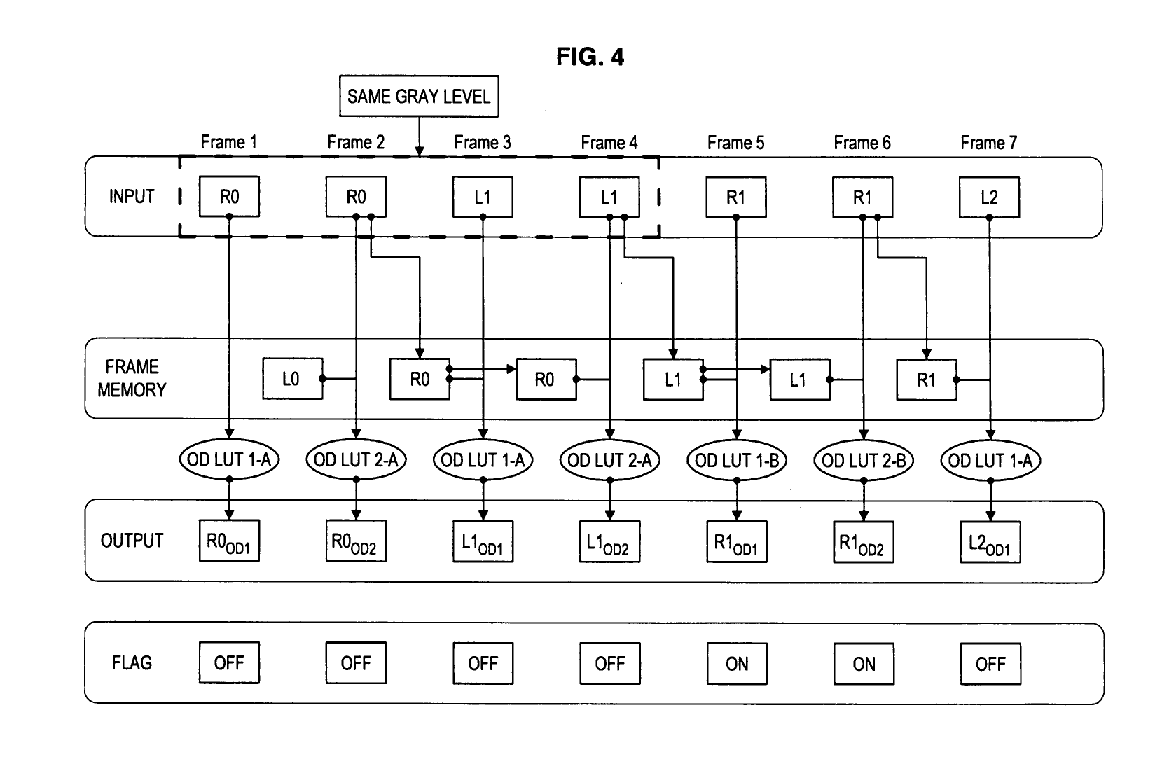

FIG. 5 is an explanatory diagram showing a flow of a series of overdrive processing concurrently using the replacement LUT. Similarly to FIG. 4, in FIG. 5, seven frames are depicted, namely the first frame (Frame 1) to the seventh frame (Frame 7). The series of the overdrive processing by the overdrive processing portion 135 will be explained with reference to FIG. 5. In the example shown in FIG. 5, it is assumed that the right eye image signal R0 and the left eye image signal L1 have the same gradation. It is assumed that the image for the left eye and the image for the right eye immediately preceding the right eye image signal R0 do not have the same gradation, and the flag in relation to the right eye image signal R0 and the left eye image signal L1 is off. As a result, until the second frame of the left eye image signal L1, the overdrive processing portion 135 applies the LUT-A to each of the image signals to perform the overdrive processing. Further, with respect to the second frame of the right eye image signal R0 and the second frame of the left eye image signal L1, the replacement LUT is referred to, and the gradation is replaced and stored in the frame memory 150.

As R0 and L1 have the same gradation, during a period in which the subsequent R1 is input (Frame 5 and Frame 6), the flag used to select the overdrive LUT is set to be on. By setting the flag used to select the overdrive LUT to be on, the LUT-B for the first frame is selected in the overdrive processing portion 135, and the overdrive processing is performed by the overdrive processing portion 135. Then, with respect to the subsequent second frame of the right eye image signal R1, the LUT-B for the second frame is selected and the overdrive processing is performed by the overdrive processing portion 135.

As L1 and R1 do not have the same gradation, during a period in which the subsequent L2 is input (Frame 7 and Frame 8, Frame 8 is not shown), the flag used to select the overdrive LUT is set to be off. By setting the flag used to select the overdrive LUT to be off, the LUT-A for the first frame is selected in the overdrive processing portion 135. Note that, although not shown in FIG. 5, the LUT-A for the second frame is also selected in the overdrive processing portion 135 with respect to the subsequent second frame of the left eye image signal L2.

In this way, by replacing the gradation of the image for the right eye or the image for the left eye to be stored in the frame memory 150 after referring to a replacement LUT, based on the gradation of the image for the left eye or the image for the right eye and on the gradation of the image that has already been stored in the frame memory 150 at a time when the gradation of the image for the left eye or the image for the right eye is to be stored in the frame memory 150, the moving image performance can be further enhanced and it becomes possible to perform overdrive processing in which the occurrence of the phenomena of crosstalk and tailing is suppressed. Note that a different replacement LUT may be used depending on a status of the flag.

The series of overdrive processing by the overdrive processing portion 135 has been explained above. In the above explanation, an example has been described in which the overdrive processing is performed while applying a different overdrive LUT to each frame of the image for the left eye or the image for the right eye. However, it is needless to mention that the series of overdrive processing by the overdrive processing portion 135 is not limited to this example. Below, other examples of the overdrive processing by the overdrive processing portion 135 will be explained.

As another example of the overdrive processing by the overdrive processing portion 135, there is a method in which the overdrive LUT and the replacement LUT are used. Here, an explanation will be made with respect to a case based on a premise of a response from a transient state and a case based on a premise of a response from a steady state. In this method, there are two overdrive LUTs and two replacement LUTs, and the overdrive LUTs and the replacement LUTs are used to perform the overdrive processing.

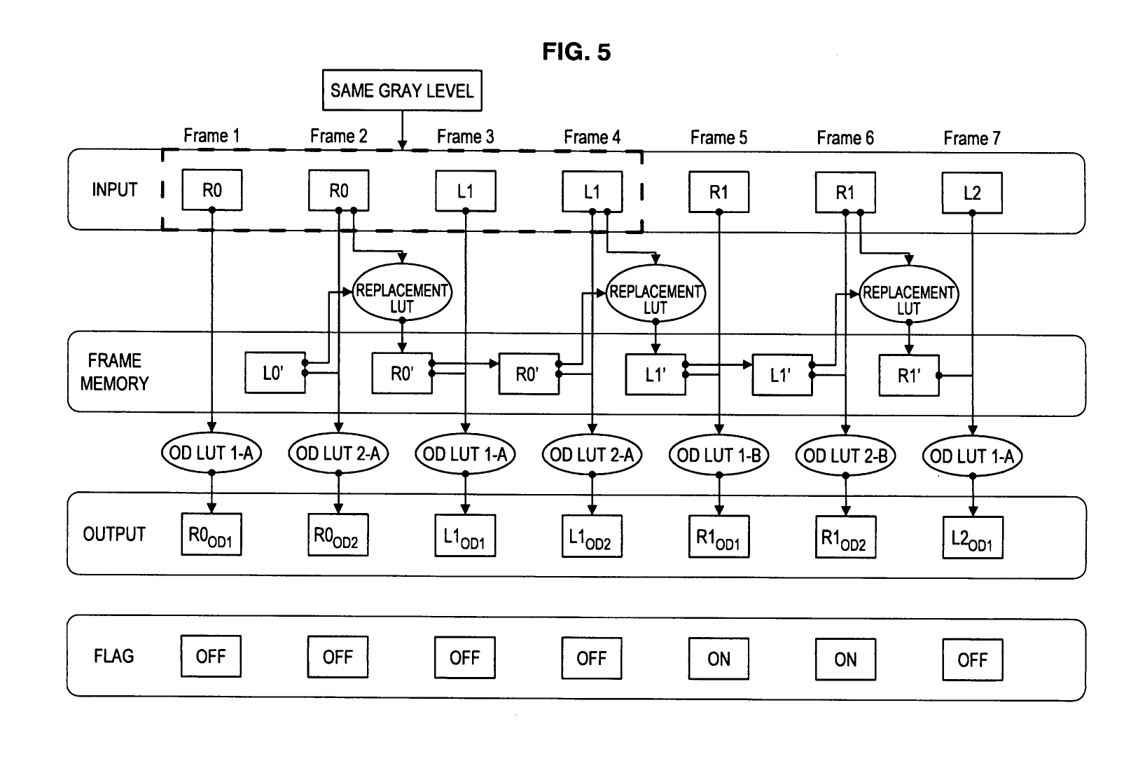

FIG. 6A to FIG. 6D are explanatory diagrams showing examples of overdrive LUTs used in the overdrive processing by the overdrive processing portion 135 and replacement LUTs used in replacement processing by the video signal control portion 120. FIG. 6A is an example of the overdrive LUT-A based on the premise of a response from a transient state. FIG. 6B is an example of a replacement LUT-A based on the premise of a response from a transient state. FIG. 6C is an example of the overdrive LUT-B based on the premise of a response from a steady state, and FIG. 6D is an example of a replacement LUT-B based on the premise of a response from a steady state.

Note that numbers shown in FIG. 6A to FIG. 6D indicate the gradation. The gradation is shown using 256 levels, with the darkest gradation being zero and the brightest gradation being 255. “START” indicates the gradation of the image for the left eye and the image for the right eye that are stored in the frame memory 150 and that are a target of processing by the overdrive processing portion 135. “DESTINATION” indicates the gradation of the image for the left eye and the image for the right eye input into the overdrive processing portion 135. Also, the numbers in each of the tables indicate parameters applied in the overdrive processing by the overdrive processing portion 135. The replacement LUT is set such that overdrive processing of the second frame is optimized. In this way, a feature of each of the look up tables used by the overdrive processing portion 135 is that, among combinations of a start gradation and a target gradation, for at least half or more of the combinations, a value of a correction amount using the LUT-A is smaller than a value of a correction amount using the LUT-B.

An example will be explained of overdrive processing using the overdrive LUT and the replacement LUT that have this type of parameter, in a case in which the image for the right eye and the image for the left eye are consecutively displayed by two frames, the gradation of the image for the right eye being 64 and the gradation of the image for the left eye being 128.

At a time when the overdrive processing portion 135 performs overdrive processing on the first frame of the image for the left eye (which has a gradation of 128), the image for the right eye (which has a gradation of 64) has already been stored in the frame memory 150. Here, when the flag is off, the overdrive LUT-A and the replacement LUT-A shown in FIG. 6A and FIG. 6B are applied. Thus, as the START value is 64 and the DESTINATION value is 128 in this case, with respect to the first frame, in accordance with the overdrive LUT-A shown in FIG. 6A, an image signal that has a gradation of 171 is output from the overdrive processing portion 135. Meanwhile, in accordance with the replacement LUT-A shown in FIG. 6B, an image signal that has a gradation of 117 is stored in the frame memory 150. Then, with respect to the second frame, the START value is 117 and the DESTINATION value is 128 and thus, in accordance with the overdrive LUT-A shown in FIG. 6A, an image signal that has a gradation of 136 is output from the overdrive processing portion 135.

On the other hand, when the flag is on, the overdrive LUT-B and the replacement LUT-B shown in FIG. 6C and FIG. 6D are applied. As the START value is 64 and the DESTINATION value is 128 in this case, with respect to the first frame, in accordance with the overdrive LUT-A shown in FIG. 6C, an image signal that has a gradation of 179 is output from the overdrive processing portion 135. Meanwhile, in accordance with the replacement LUT-A shown in FIG. 6D, an image signal that has a gradation of 108 is stored in the frame memory 150. Then, with respect to the second frame, the START value is 117 and the DESTINATION value is 128 and thus, in accordance with the overdrive LUT-A shown in FIG. 6C, an image signal that has a gradation of 145 is output from the overdrive processing portion 135.

In this way, in this example also, it is possible to make settings such that the correction amount using the overdrive LUT-B is larger than the correction amount using the overdrive LUT-A.

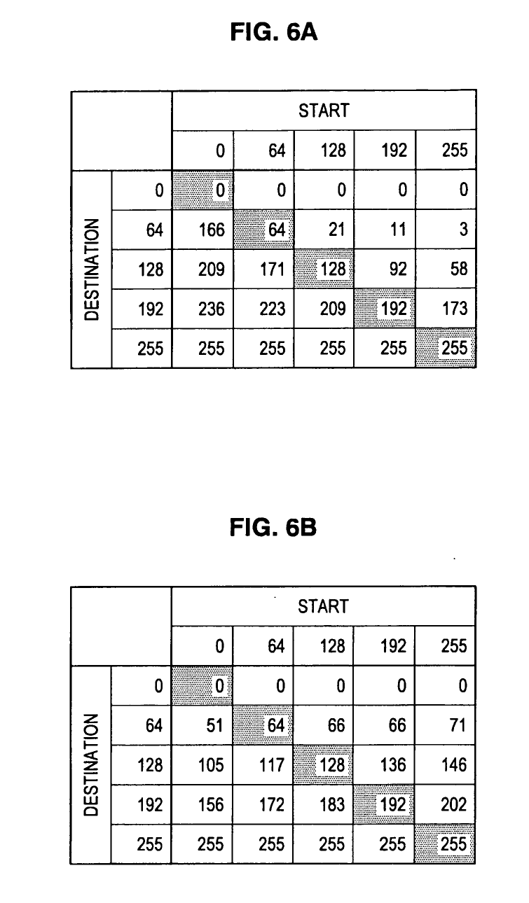

FIG. 7 is an explanatory diagram showing a flow of a series of overdrive processing by the overdrive processing portion 135 of the display device 100 according to the embodiment of the present invention.

In FIG. 7, “INPUT” indicates, in units of frames, a video signal input to the video signal control portion 120. R0, R1 etc. indicate the right eye image signal, while L0, L1, L2 etc. indicate the left eye image signal. Similarly to FIG. 4, seven frames are depicted in FIG. 7, namely the first frame (Frame 1) to the seventh frame (Frame 7).

In addition, in FIG. 7, “FRAME MEMORY” indicates a video signal stored in the frame memory 150. In FIG. 7, an example is shown in which the first frame of the image signal is stored in the frame memory 150 using the replacement LUT, and the second frame of the image signal is stored as it is in the frame memory 150. Thus, as shown in FIG. 7, the image signal stored in the frame memory 150 is updated each frame.

Further, in FIG. 7, “OUTPUT” indicates results of the overdrive processing performed on the right eye image signal or on the left eye image signal and is a video signal output from the overdrive processing portion 135, shown in units of frames. In addition, in FIG. 7, “FLAG” indicates a state of a flag used to select the overdrive LUT to be applied by the overdrive processing portion 135 and to select the replacement LUT applied by the video signal control portion 120.

The series of overdrive processing by the overdrive processing portion 135 will be explained with reference to FIG. 7. In the example shown in FIG. 7, it is assumed that the right eye image signal R0 and the left eye image signal L1 have the same gradation. It is assumed that the image for the left eye and the image for the right eye immediately preceding the right eye image signal R0 do not have the same gradation, and the flag in relation to the right eye image signal R0 and the left eye image signal L1 is off. As a result, until the second frame of the left eye image signal L1, the overdrive processing portion 135 applies the LUT-A to each of the image signals to perform the overdrive processing. In addition, the gradations of the first frame of the right eye image signal R0 and the first frame of the left eye image signal L1 are replaced by the video signal control portion 120 using the replacement LUT-A and then the first frame of the right eye image signal R0 and the first frame of the left eye image signal L1 are stored in the frame memory 150. Furthermore, the second frame of the right eye image signal R0 and the second frame of the left eye image signal L1 are stored in the frame memory 150 without replacing the gradation.

As R0 and L1 have the same gradation, during a period in which the subsequent R1 is input (Frame 5 and Frame 6), the flag used to select the overdrive LUT and the replacement LUT is set to be on. By setting the flag used to select the overdrive LUT to be on, the overdrive LUT-B is selected in the overdrive processing portion 135, and the overdrive processing is performed by the overdrive processing portion 135. Further, by setting the flag to be on, the replacement LUT-B is also selected in the video signal control portion 120. The gradation of the first frame of the right eye image signal R1 is replaced using the replacement LUT-B and then the first frame of the right eye image signal R1 is stored in the frame memory 150. Then, with respect to the subsequent second frame of the right eye image signal R1, the LUT-B is also selected and the overdrive processing is performed by the overdrive processing portion 135.

Here, among a plurality of frames that output the same image for the left eye or image for the right eye, in order to optimize the overdrive processing for the first frame, it is preferable for the gradation of the frame memory 150 applied in the overdrive processing for the first frame to be equal to an input gradation (a value before overdrive processing and replacement processing) of the image preceding the first frame (namely, if the image that is the target of the overdrive processing is the image for the left eye, the image for the right eye). However, depending on a set value of the replacement LUT, it is possible that the image is stored in the frame memory 150 that has a gradation different to the input gradation. Therefore, in order to prevent the image that has a gradation different to the input gradation from being stored in the frame memory 150, the replacement processing using the replacement LUT may not be performed with respect to the final frame of the plurality of frames that output the same image for the left eye or image for the right eye, as shown in FIG. 7.

The example of the overdrive processing by the overdrive processing portion 135 using the different overdrive LUT and replacement LUT has been explained above.

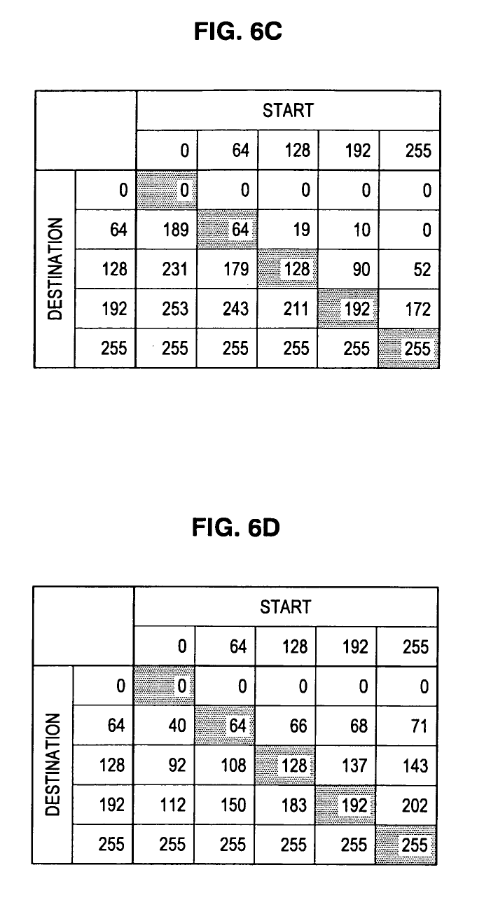

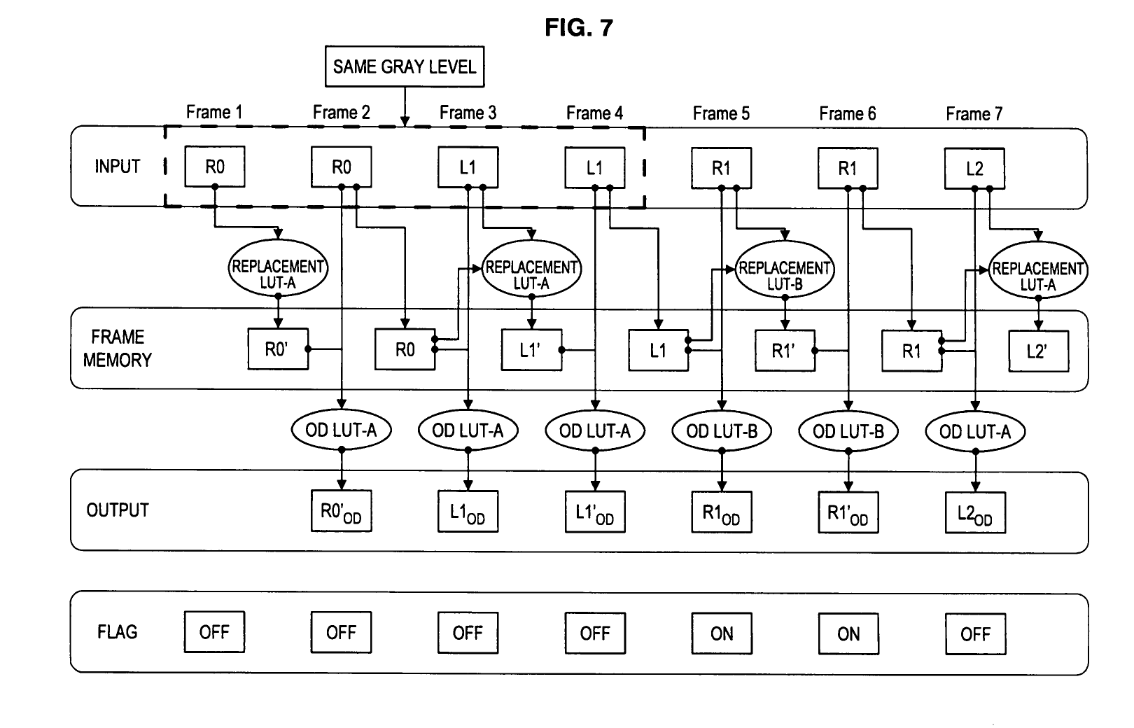

Besides, in the above-described overdrive processing by the overdrive processing portion 135, a case is exemplified in which the same overdrive parameters are applied to all of the plurality of frames. However, the present invention is not limited to this example. Overdrive processing may be performed such that the overdrive parameters applied to some of the plurality of frames are different to the overdrive parameters applied to the other frames. FIG. 8 and FIG. 9 are explanatory diagrams respectively showing a flow of a series of overdrive processing by the overdrive processing portion 135 when overdrive parameters applied to the second frame are different to the overdrive parameters applied to the first frame. Similarly to FIG. 4, seven frames are depicted in FIG. 8 and FIG. 9, namely the first frame (Frame 1) to the seventh frame (Frame 7). In FIG. 8, an example is shown in which the LUT-B (OD LUT 1-B) is applied to the first frame of the image for the right eye in Frame 5, and the LUT-A (OD LUT 2-A) is applied to the second frame of the image for the right eye in Frame 6. In FIG. 9, an example is shown in which the LUT-B (OD LUT-B) is applied to the first frame of the image for the right eye in Frame 5, and the LUT-A (OD LUT-A) is applied to the second frame of the image for the right eye in Frame 6.

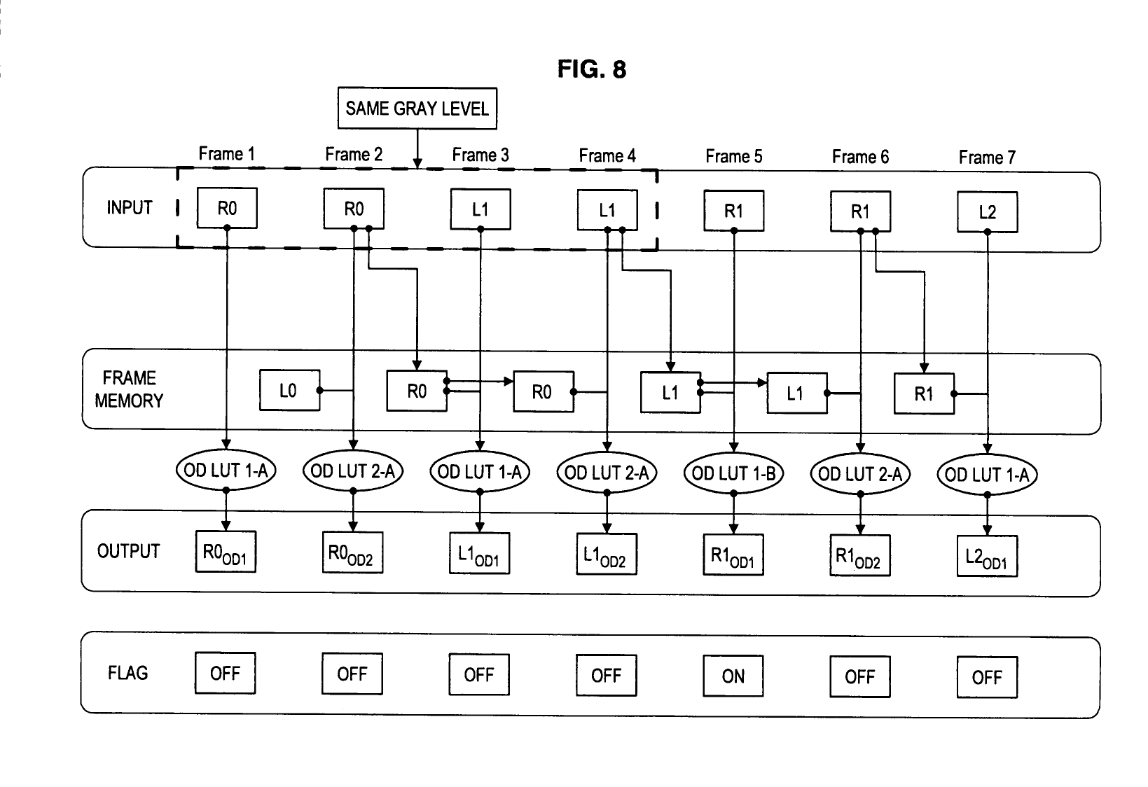

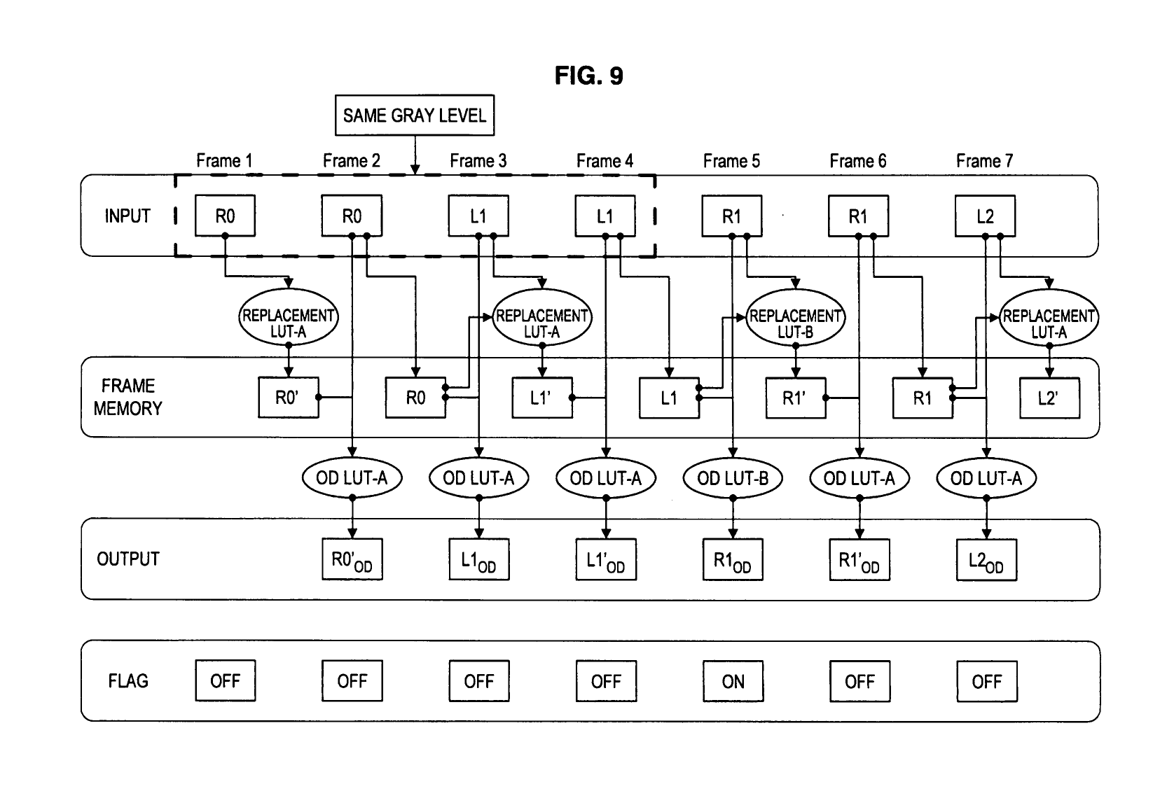

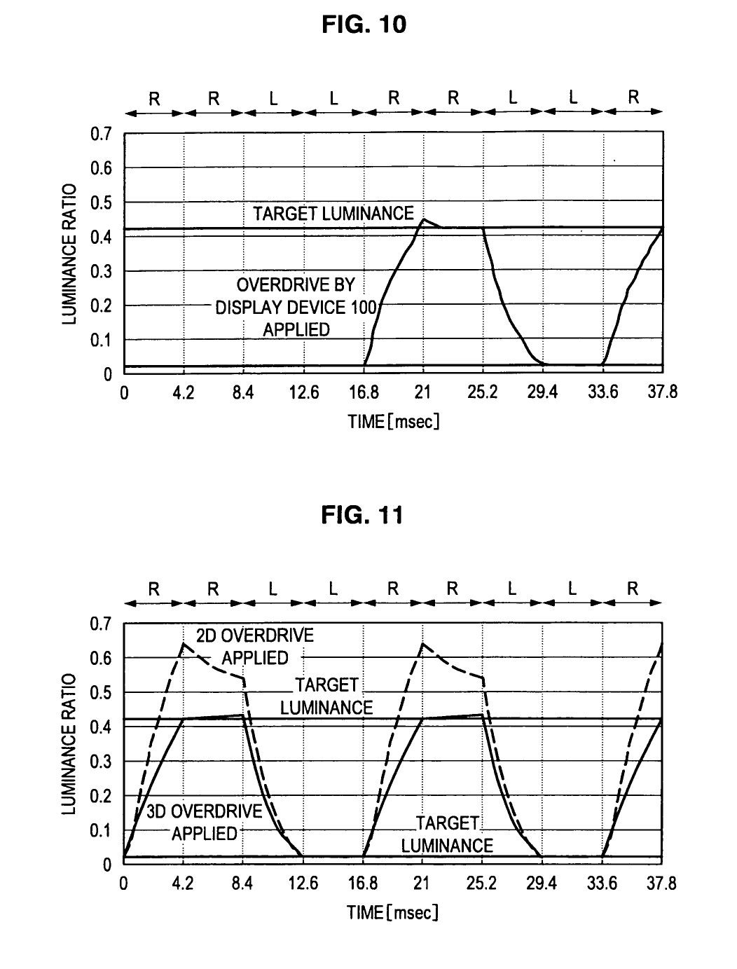

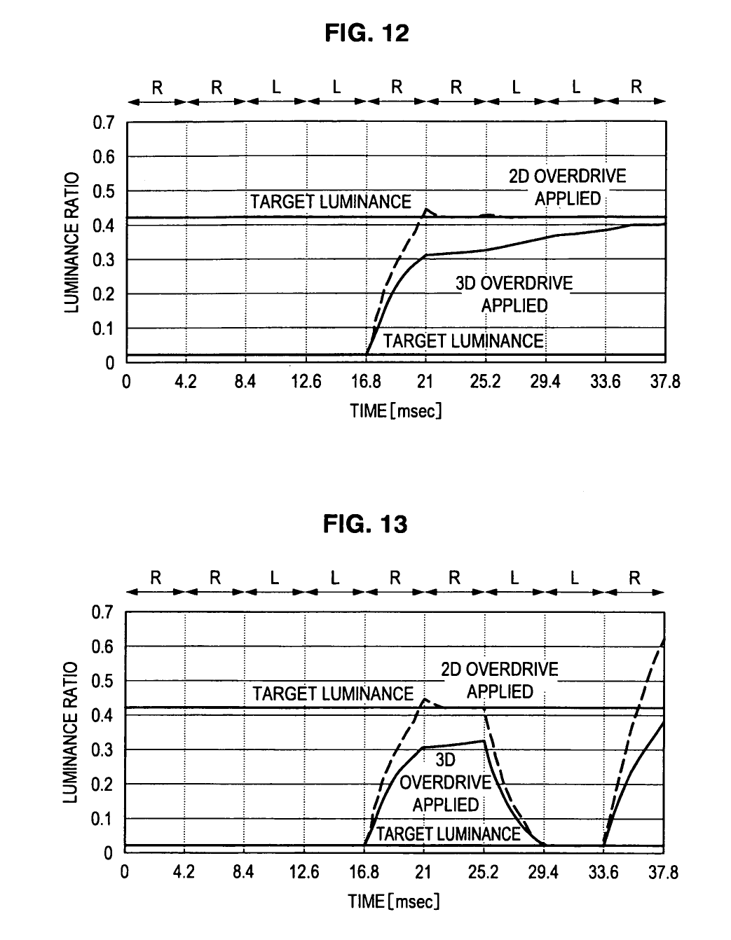

FIG. 10 is an explanatory diagram showing an example of a response waveform in a case of a transition from a steady state to 3D display (repeated display of the image for the right eye and the image for the left eye), when the overdrive processing is performed by the display device 100 according to the embodiment of the present invention. By performing the overdrive processing by the display device 100 according to the embodiment of the present invention, it can be seen from FIG. 10 that, in comparison to a response waveform shown in FIG. 13, the phenomenon of tailing (caused by insufficient response) immediately after the transition from the steady state does not occur, and after that, there is no deviation from a target luminance.

### 2. CONCLUSION

As described above, according to the embodiment of the present invention, in the display device 100 that displays an image for the left eye and an image for the right eye by a plurality of consecutive frames and sequentially switches the image for the left eye and the image for the right eye, a plurality of overdrive parameters are prepared. Depending on difference in gradation among the plurality of consecutive images for the left eye or for the right eye before overdrive processing, the overdrive parameter is selected that will be applied during a period of the plurality of frames over which the next image is displayed. The display device 100 selects the overdrive parameter depending on the difference between the gradation of the image for the left eye and the gradation of the image for the right eye and performs the overdrive processing. It is thus possible to suppress the occurrence of the phenomena of crosstalk and tailing.

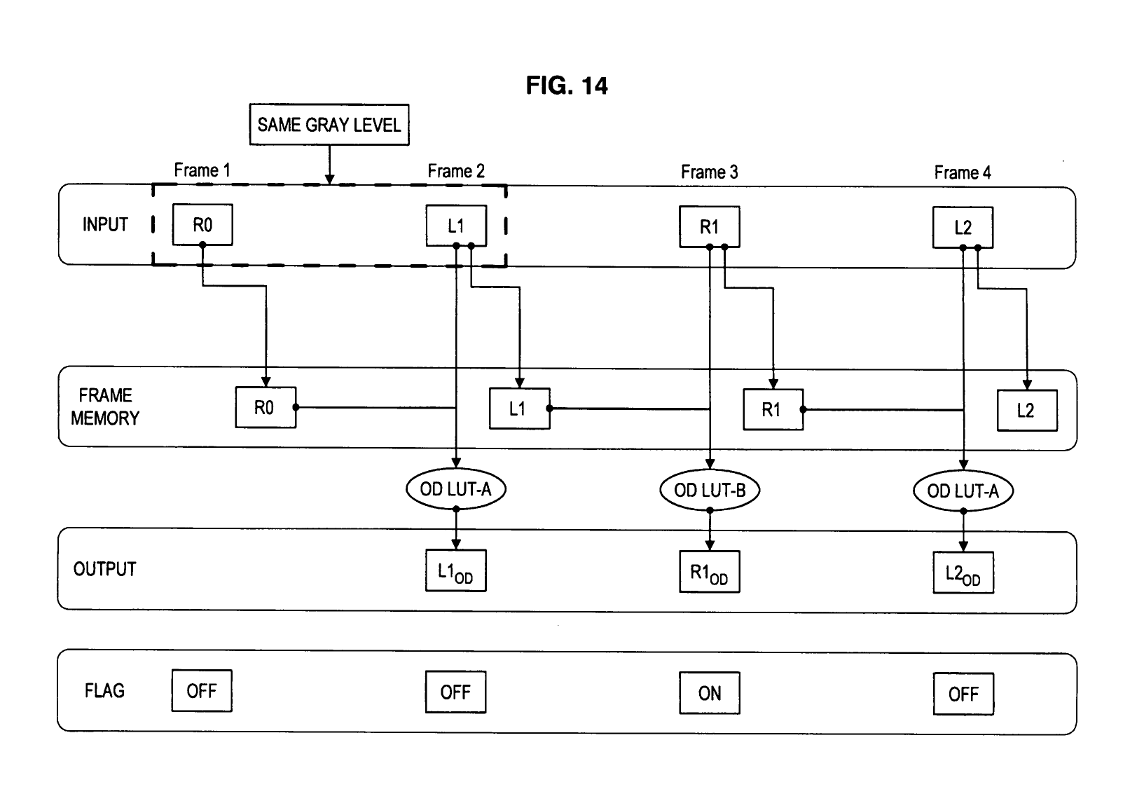

Besides, in the above-described example, a case is explained in which the display device 100 consecutively displays the images for the right eye and the images for the left eye by a plurality of frames. However, the present invention is not limited to this example. FIG. 14 is an explanatory diagram showing a flow of a series of overdrive processing in a case where, on the display device 100 according to the embodiment of the present invention, the image for the right eye and the image for the left eye are consecutively displayed by one frame.

The above-described series of overdrive processing may be performed by hardware or may be performed by software. When the series of overdrive processing is performed by software, it may be performed, for example, a recording medium having a program stored thereon may be integrated into the display device 100. Then, the program may be read out and sequentially executed by a control device, such as a central processing unit (CPU) or a digital signal processor (DSP), which is integrated into the display device 100.

It should be understood by those skilled in the art that various modifications, combinations, sub-combinations and alterations may occur depending on design requirements and other factors insofar as they are within the scope of the appended claims or the equivalents thereof.

For example, in the above-described embodiment, examples are described in which the display device 100 displays stereoscopic images, but the present invention is not limited to these examples. For example, the present invention may be applied to a display device that performs multi-view display, using a time-division shutter scheme to display different video to a plurality of viewers. In contrast to a case of causing stereoscopic viewing, multi-view display controls a shutter such that an image can only be seen through special shutter glasses during a predetermined time period, and can thus cause a plurality of images to be displayed on a single display device.

1. A display device, comprising:
a display;
a video signal control portion; and
a processing portion for detecting a gradation difference between a first frame and a second frame of a video signal, determining whether the gradation difference is of a first state or a second state, and changing a target value of an output of the display based on the result of the determining operation.

2. The display device according to claim 1, wherein the processing portion is an overdrive processing portion, and changing a target value comprises changing an overdrive parameter.

3. The display device according to claim 2, wherein changing an overdrive parameter comprises changing a correction amount that is applied through overdrive processing.

4. The display device according to claim 3, wherein the correction amount that is applied through overdrive processing is based on a lookup table, and changing the correction amount comprises changing the lookup table.

5. The display device according to claim 1, wherein the display is a liquid crystal display.

6. The display device according to claim 1, wherein the first state is a transient state and the second state is a steady state.

7. The display device according to claim 1, wherein the target value corresponds to a third frame of the video signal.

8. The display device according to claim 7, wherein each of the first, second and third frames are displayed twice and the processing portion changes a target value for the first display of the third frame and for the second display of the third frame such that the target value for the first display of the third frame is different from the target value for the second display of the third frame.

9. The display device according to claim 1, further comprising a memory for storing the second frame of the video signal, the memory supplying the second frame to the processing portion, and the processing portion using both the supplied frame and the result of the determining operation as the basis for changing the target value.

10. The display device according to claim 9, further comprising a memory for storing a replacement frame corresponding to the first frame of the video signal, the memory supplying the replacement frame to the processing portion, and the processing portion using both the supplied frame and the result of the determining operation as the basis for changing the target value.

11. The display device according to claim 9, further comprising a memory for storing a replacement frame corresponding to the second frame of the video signal, the memory supplying the replacement frame to the processing portion, and the processing portion using both the supplied frame and the result of the determining operation as the basis for changing the target value.

12. A display method, comprising:
detecting a gradation difference between a first frame and a second frame of a video signal;
determining whether the gradation difference is of a first state or a second state; and
changing a target value of an output of a display based on the result of the determining step.

13. The display method according to claim 12, wherein the step of changing a target value comprises changing an overdrive parameter.

14. The display method according to claim 13, wherein changing an overdrive parameter comprises changing a correction amount that is applied through overdrive processing.

15. The display method according to claim 14, wherein the correction amount that is applied through overdrive processing is based on a lookup table, and changing the correction amount comprises changing the lookup table.

16. The display method according to claim 12, wherein the display is a liquid crystal display.

17. The display method according to claim 12, wherein the first state is a transient state and the second state is a steady state.

18. The display method according to claim 12, wherein the target value corresponds to a third frame of the video signal.

19. The display method according to claim 18, wherein each of the first, second and third frames are to be displayed twice and the processing portion changes a target value for the first display of the third frame and for the second display of the third frame such that the target value for the first display of the third frame is different from the target value for the second display of the third frame.

20. The display method according to claim 12, wherein the step of changing the target value comprises changing the target value based on the second frame of the video signal and the result of the determining step.

21. The display method according to claim 20, wherein the step of changing the target value comprises changing the target value based on a replacement frame corresponding to the first frame of the video signal and the result of the determining step.

22. The display method according to claim 20, wherein the step of changing the target value comprises changing the target value based on a replacement frame corresponding to the second frame of the video signal and the result of the determining step.

23. A non-transitory computer-readable medium storing a computer-readable program for implementing a display method, the display method comprising:
detecting a gradation difference between a first frame and a second frame of a video signal;
determining whether the gradation difference is of a first state or a second state; and
changing a target value of an output of a display based on the result of the determining step.
